(19) United States
(12) Patent Application Publication
(10) Pub. No.: US 2025/0347305 A1
(43) Pub. Date: Nov. 13, 2025

(54) REINFORCED POLYMER CONNECTOR PLATE AND RELATED METHOD OF MANUFACTURE

(71) Applicants: Kathleen Nieuwenhuys, Krugersdorp (ZA); Willem Frederick Steenberg, Johannesburg (ZA)

(72) Inventors: Kathleen Nieuwenhuys, Krugersdorp (ZA); Willem Frederick Steenberg, Johannesburg (ZA)

(21) Appl. No.: 19/205,435

(22) Filed: May 12, 2025

(30) Foreign Application Priority Data
May 10, 2024 (ZA) 2024/03595

(51) Int. Cl. F16B 5/07; B29D 21/00

(52) U.S. Cl. CPC F16B 5/07; B29D 21/00

(57) ABSTRACT

According to a first aspect of the invention, there is provided a polymer connector plate, and in particular a fibre reinforced polymer connector plate, the connector plate comprising a polymer connector plate base; and a plurality of polymer legs extending from the plate base. According to a second aspect of the invention, there is provided a method of manufacturing a polymer connector plate, the method comprising extruding raw plastic polymer material, typically comprising fibre reinforced polymer pellets, to define the polymer connector plate defined above. According to a third aspect of the first embodiment of the invention, there is provided an apparatus for manufacturing a polymer connector plate, and in particular a fibre reinforced polymer connector plate, the apparatus comprising an injection moulding apparatus.

### FIELD OF THE INVENTION

This invention relates to reinforced polymer connector plates, including but not limited to gang nails, and split or truss plates. These connector plates are typically used in wooden applications where it is required to join two or more wooden components, including the joining together of roof trusses, pallets and bedding components, to prevent wood from splitting. A further application relates to wooden poles where split plates are used to strengthen the pole, to prevent shattering or splitting.

### BACKGROUND OF THE INVENTION

Traditionally, connector plates 10, of the type shown in FIG. 1, are made, with reference to FIG. 2, from a continuous strip of steel sheet material 12 incrementally fed into a punch press 14 from a metal sheet coil 16. Generally, the width of the strip 12 is the same width of the gang nail or connector plate 10 to ensure no additional scrap of the material. In particular, the shape (width/length and breadth) is the same as the semi-extract from the plate once it is formed by the punching process. The punch press 14 process includes the punching of the material 12 to create legs 18 and then the bending of the punched material to define legs 18 that extend at 90° relative to the base 20 of the plate 10. The plate 10 may, in use, be pressed or hammered into wood to connect and secure 2 or more pieces of wood or to serve as protection to splitting in the case of a wooden pole. The limitation of traditional connector plates 10 is that the plate legs 18 are inherently part of the base 20 itself, and therefore can be opposite to each other or face each other but cannot face in a different direction, left or right, from each other. The second limitation is that the plate legs 18 will always be the same thickness as that of the base 20 of the material strip 12 used. These limitations apply to gang nails, and split or truss plates.

Thus, the traditional method of manufacturing a connector plate 10 includes feeding metal material 12, which may be either galvanized to ensure corrosion or rust protection or non-galvanised, through a series of pressing, punching, bending and cutting processes to produce the connector plate 10 shown in FIG. 1.

In terms of known prior art, U.S. Pat. No. 4,209,265A describes a connector system in the form of a gang nail or connector plate that is made from commercial sheet steel or the like. The manufacturing process of the connector plate and the material used ensures sufficient resistance against tension, shear loads and resist bending in the plane of the connectors. The invention provides a product that will sufficiently withstand the stresses of handling, transportation and erection.

U.S. Pat. No. 4,782,641A discloses a rectangular metal connector plate that is made from sheet metal that may be 18-gauge sheet steel and galvanized if required. The invention in this document concentrates on the design of the plate, and is referred to as a scissors truss connector plate that is formed to ensure the efficiency of joining wooden components together when forming a wooden truss used in a roof application. The limitation identified is that the thickness of the plate legs is directly linked to the thickness of the plate. In other words, if the plate is 1.2 mm thick, the plate legs cannot be thicker than 1.2 mm as well; the legs may have teeth but will always be 1.2 mm thick. The punch process semi-extracts the material needed to form the plate legs from the plate, bending the legs according to the specified requirement, typically at a 90° angle. Again, the legs will be formed in a pattern and will always face each other directly or in the opposite direction but cannot be formed by turning and facing left or right to the plate leg in front or behind.

There is thus a need to provide connector plates, including but not limited to gang nails, and split or truss plates, that address the above shortcomings of conventional metal connector plates.

### SUMMARY OF THE INVENTION

At a high level, the present invention provides a high compression and withholding strength polymer connector plate, and in particular a fibre reinforced polymer connector plate, and related method of manufacture.

According to a first aspect of the invention, there is provided a polymer connector plate, and in particular a fibre reinforced polymer connector plate, the connector plate comprising:
a polymer connector plate base; and
a plurality of polymer legs extending from the plate base.

In an embodiment, the length, breadth (defined by a pair of opposed major faces), and width (defined by a pair of opposed minor faces or edges) of each leg are independent of the thickness of the plate base, and may vary from leg to leg.

In addition, the legs may be orientated at any angle relative to each other. In one example, each leg (and in particular the major faces) is orientated at 90° relative to an adjacent leg, but clearly the legs may be orientated at any angle relative to other legs.

The legs can be of any size and shape. In an embodiment, the leg comprises a leg base from which the opposed major and minor faces extend, the major and minor faces terminating in an upper leg surface. In an embodiment, the area of the upper leg surface is smaller than the area of the leg base, so that the cross-sectional area of the leg tapers from the leg base to the upper leg surface.

In an embodiment, the polymer connector plate base defines a plurality of apertures between the legs, thus providing a saving in material.

According to a second aspect of the invention, there is provided a method of manufacturing a polymer connector plate, the method comprising extruding raw plastic polymer material, typically comprising fibre reinforced polymer pellets, to define the polymer connector plate defined above.

According to a third aspect of the first embodiment of the invention, there is provided an apparatus for manufacturing a polymer connector plate, and in particular a fibre reinforced polymer connector plate, the apparatus comprising:
an injection moulding apparatus comprising a hopper to receive raw plastic polymer material, typically comprising fibre reinforced polymer pellets, and an injection moulding housing accommodating a reciprocating barrel and screw for delivering an extruded polymer compound; and
a mould for receiving the extruded polymer compound, the mould being arranged to define the polymer connector plate defined above.

The present invention thus suggests that the polymer connector plate may be manufactured using reinforced polymer pellets that may be processed using injection moulding.

The pellets are supplied though a hopper to the injection moulding apparatus, where the polymer connector plate is formed with legs, shaped and facing the ideal direction to ensure effective and efficient joining requirements within the specific wood application.

In an embodiment, the apparatus further includes a product conveyor to transport the moulded polymer connector plates towards a sorting arrangement, which is arranged to either move the connector plates to a packing area or to product runners, if required.

### BRIEF DESCRIPTION OF DRAWINGS

The objects of this invention and the manner of obtaining them, will become more apparent, and the invention itself will be better understood, by reference to the following description of embodiments of the invention taken in conjunction with the accompanying diagrammatic drawing, wherein:

FIG. 1 shows a perspective view of a conventional metal connector plate;

FIG. 2 shows a typical manufacturing process for making the metal connector plate shown in FIG. 1;

FIG. 3 shows a bottom perspective view of a polymer connector plate according to one version of the present invention, the connector plate comprising a polymer connector plate base and a plurality of polymer legs extending from the plate base;

FIG. 4 shows various views of one of the polymer legs shown in FIG. 3;

FIG. 5 shows a top view of the polymer connector plate shown in FIG. 3;

FIG. 6 shows a manufacturing apparatus and process to make the polymer connector plate shown in FIG. 3;

FIG. 7 shows other possible shapes and configurations of the polymer legs that may be used in the present invention;

FIG. 8 shows another embodiment of the polymer connector plate, in which the polymer legs are arranged randomly on the polymer connector plate base; and

FIGS. 9 and 10 show further possible embodiments of the polymer connector plate of the present invention.

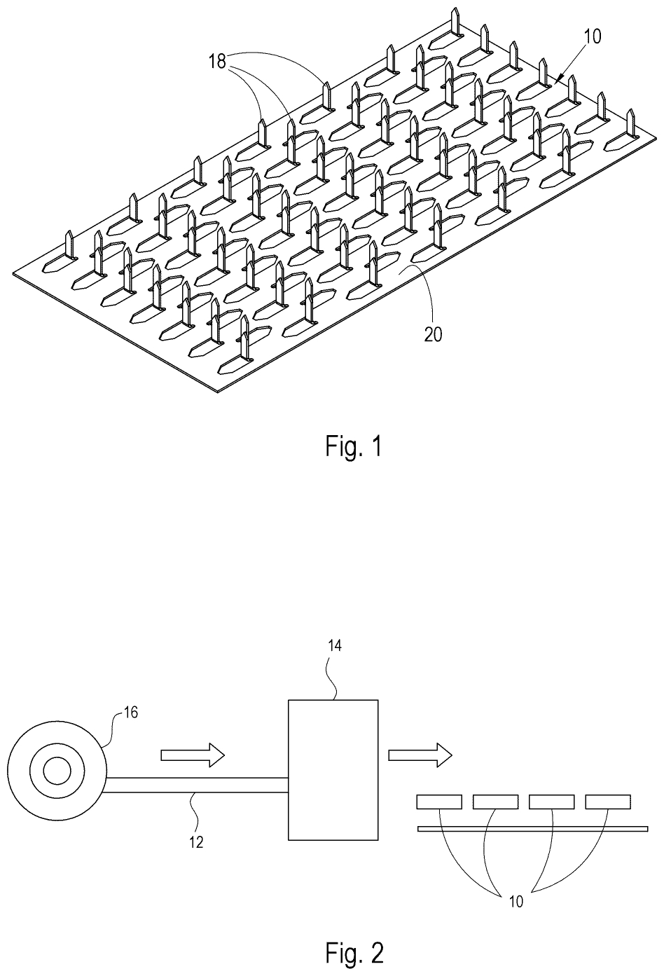

### DETAILED DESCRIPTION OF EXAMPLE EMBODIMENTS

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

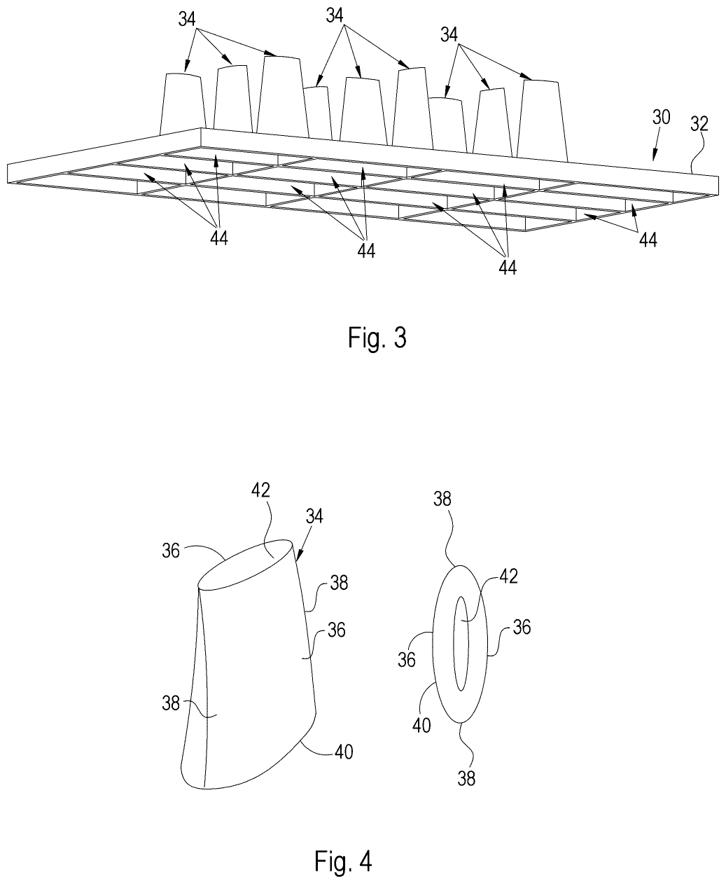

Referring first to FIGS. 3 to 5, this invention provides a polymer connector plate 30, and in particular a fibre reinforced polymer connector plate 30. The connector plate 30 comprises a polymer connector plate base 32 and a plurality of polymer legs 34 extending from the plate base 32.

In an embodiment, the length, breadth (defined by a pair of opposed major faces 36), and width (defined by a pair of opposed minor faces or edges 38) of each polymer leg 34 are independent of the thickness of the plate base 32, and may even vary from leg to leg. In other words, the size and shape of the legs 34 are not dependent on the size of the plate base 32. In addition, within the same plate 30, the lengths of the polymer legs 34, relative to the plate base 32, may vary. For example, 5 mm polymer legs 34 may be interspersed with 10 mm legs 34.

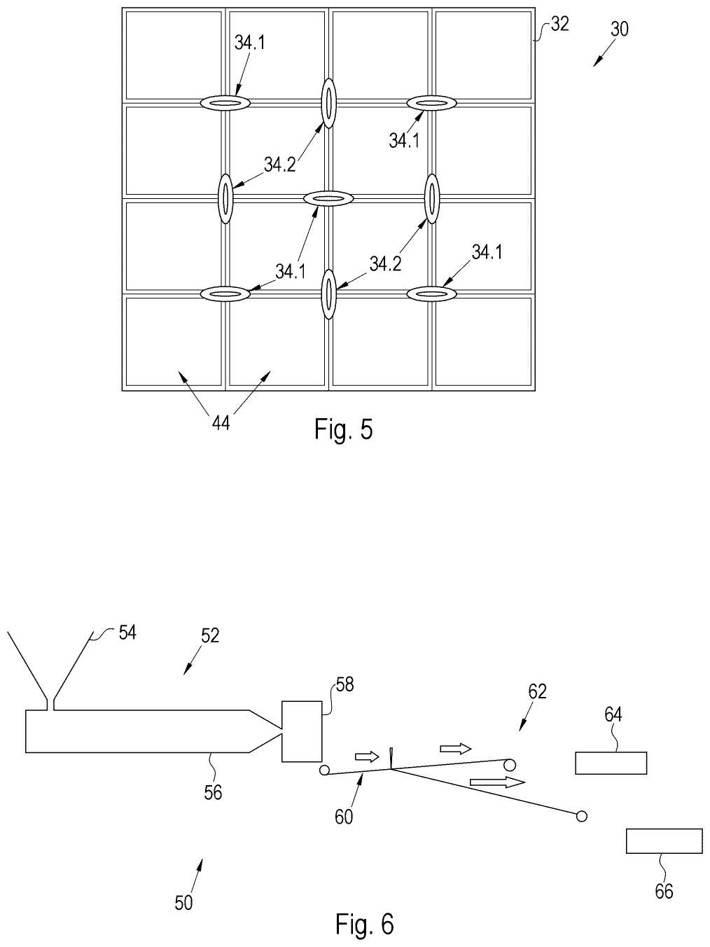

In addition, the polymer legs 34 may be orientated at any angle relative to each other (and even to the base plate 32 itself). In one example, as shown in FIGS. 3 and 5, legs 34.1 (and in particular the major faces 36) are orientated at 90° relative to adjacent legs 34.2. Clearly, the legs 34 may be orientated at any angle relative to other legs 34.

By orienting the legs 34 of the connector plate 30 at different angles, the connector plate 30 can better engage with the wood fibers, maximising holding strength and minimizing the risk of splitting along the grain. Variable leg lengths can also help penetrate different wood thicknesses or densities, further enhancing the connector plate's adaptability. Legs of varying lengths and orientations can resist different types of forces more effectively. For example, longer legs 34 can provide greater resistance to pull-out forces, while legs 34 oriented at angles can counteract shear forces that occur when the joined wooden components are subjected to lateral loads.

In addition, the polymer legs 34 can be of any size and shape. In an embodiment, the polymer leg 34 comprises a leg base 40 from which the opposed major and minor faces 36, 38 extend, the major and minor faces 36, 38 terminating in an upper leg surface 42. In an embodiment, the area of the upper leg surface 42 is smaller than the area of the leg base 40, so that the cross-sectional area of the leg 34 tapers from the leg base 40 to the upper leg surface 42.

In an embodiment, the polymer connector plate base 32 defines a plurality of apertures 44 between the legs 34, thus providing a saving in material.

Turning now to FIG. 6, an apparatus 50 for manufacturing a polymer connector plate, and in particular a fibre reinforced polymer connector plate 30 of the type defined above, is shown. The apparatus 50 comprises an injection moulding apparatus 52 comprising a hopper 54 to receive raw plastic polymer material, typically comprising fibre reinforced polymer pellets, and an injection moulding housing 56 accommodating a reciprocating barrel and screw for delivering an extruded polymer compound.

The apparatus 50 further comprises a mould 58 for receiving the extruded polymer compound, the mould 50 being arranged to define the polymer connector plate 30 defined above.

The present invention thus suggests that the polymer connector plate 30 may be manufactured using reinforced polymer pellets that may be processed using injection moulding. The pellets are supplied though the hopper 54 to the injection moulding apparatus 52, where the polymer connector plate 30 is formed with legs, shaped and facing the ideal direction to ensure effective and efficient joining requirements within the specific wood application.

In an embodiment, the apparatus 50 further includes a product conveyor 60 to transport the moulded polymer connector plates 30 towards a sorting arrangement 62, which is arranged to either move the connector plates 30 to a packing area 64 or to product runners 66, if required.

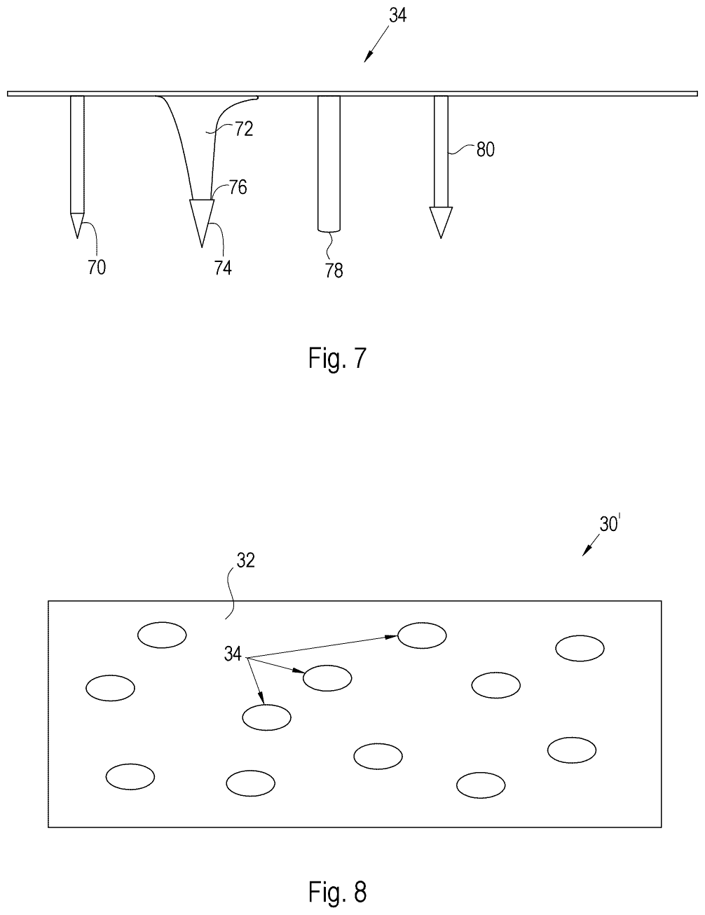

Turning now to FIG. 7, other possible shapes and configurations of the polymer legs 34 that may be used in the present invention. These include a polymer leg 34 with a sharp point 70; a polymer leg 34 with a tapering leg shank 72 with a sharp point 74 and a shoulder 76; a polymer leg 34 with a blunt point 78; and a polymer leg 34 with a plain shank or a fluted shank 80 with lines to assist in improving its withholding strength. Again, as indicated above, within the same plate 30, in addition to the lengths of the polymer legs 34 being variable, the shapes of the polymer legs 34 of the same plate 30 may vary as well.

FIG. 8 shows another embodiment of the polymer connector plate 30′, in which the polymer legs 34 are arranged randomly on the polymer connector plate base 32.

The advantage of randomly arranged polymer legs 34 is that this assists with the effectiveness of the plate 30′ and potentially decreases the number of legs 34 required to achieve the desired result, in use.

In one version, apertures 44 between the legs 34, of the type described above, may be provided as well, as shown in FIGS. 3 and 5.

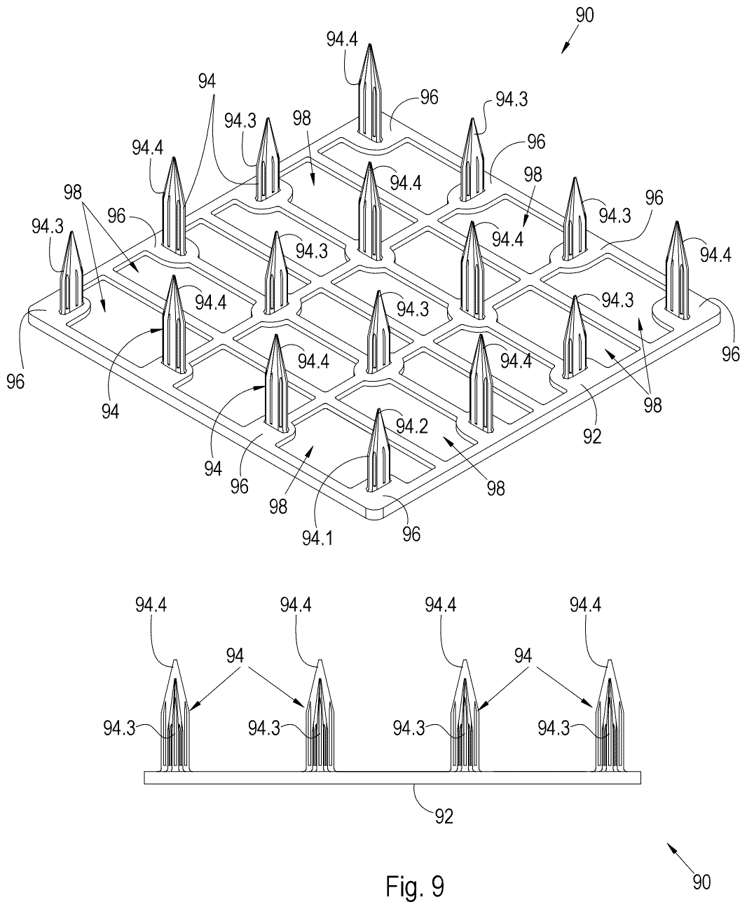

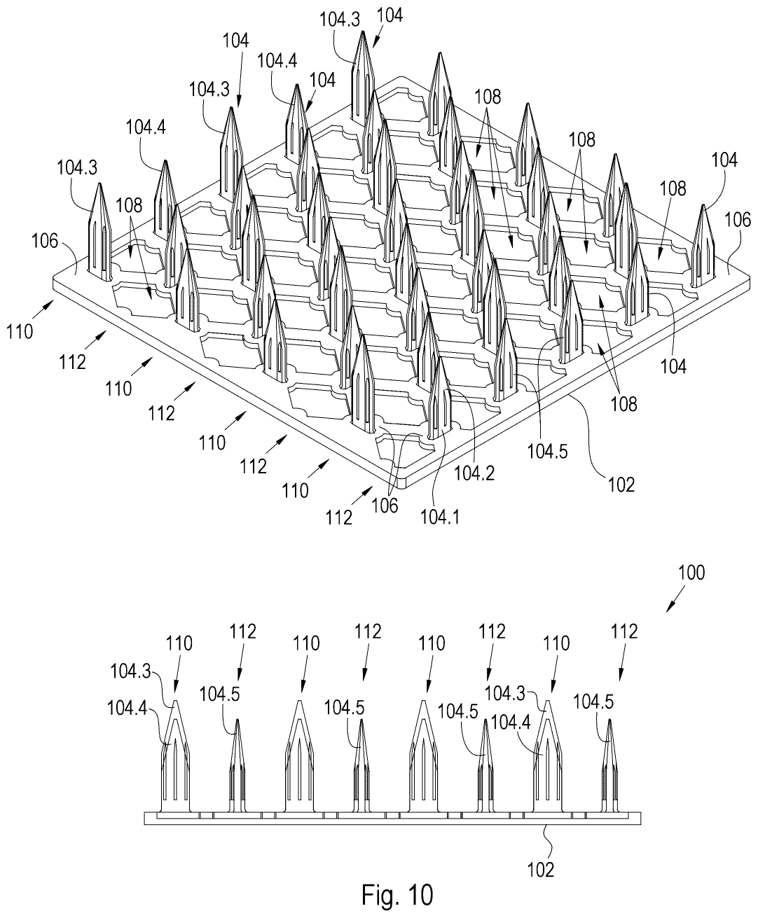

FIGS. 9 and 10 show further possible embodiments of a polymer connector plate of the present invention.

In FIG. 9, the polymer connector plate 90 includes a plate base 92 from which a plurality of polymer legs 94 extend. The plate base 92 includes a plurality of support surfaces or landings 96, which in turn defines a plurality of apertures 98 between the polymer legs 94. In this version, the polymer legs 94 are relatively flat, comprising a flat base 94.1 and a tapering or sharpened tip 94.2. In addition, the polymer legs 94 are arranged to face in different directions. For example, legs 94.3 face the same first direction and legs 94.4 face the same second direction, with the first and second directions, when viewed from the top, being at 90 degrees relative to each other. In addition, in this particular version, legs 94.3 are slightly shorter than legs 94.4.

In FIG. 10, the polymer connector plate 100 includes a plate base 102 from which a plurality of polymer legs 104 extend. The plate base 102 includes a plurality of support surfaces or landings 106, which in turn defines a plurality of apertures 108 between the polymer legs 104. In this version, the polymer legs 104 are relatively flat, comprising a flat base 104.1 and a tapering or sharpened tip 104.2. Again, the polymer legs 104 are arranged to face in different directions, but in this case, the polymer legs 104.3, 104.4 in rows 110 face in the same first direction, whereas the polymer legs 104.5 in row 112 face in the same second direction. The first and second directions, when viewed from the top, are at 90 degrees relative to each other. In addition, in this particular version, legs 104.3 are slightly longer than legs 104.4, whereas legs 104.5 are all the same length, and in this case, similar to legs 104.4 (but not necessarily so).

With the current invention, fibre reinforced polymer is used to form the plate base 32, 92, 102 and the legs 34, 94, 104 that extend from the plate base 32, 92, 102 forming one product 30, 30′, 90, 100. The property of the reinforced polymer leads to rust and corrosion protection, thus overcoming the need for a second process to provide this protection. The design of the plate base 32, 92, 102 and the polymer legs 34, 94, 104 are unlimited resulting out of the raw material used and the moulding process. The shape of the legs 34, 94, 104 of the plate 30, 30′, 90, 100 can be round, triangular or any other shape necessary to ensure an effective application to join, for example, the 2 or more wooden components to each other. The legs 34, 94, 104 can be formed anywhere on the plate base 32, 92, 102, either in terms of a specific pattern (of the type shown in FIGS. 3, 5, 9 and 10) or they may be randomly scattered on the plate base 32, 92, 102 (as shown in FIG. 8). The legs 34, 94, 104 can face each other or be opposite of each other; the legs 34, 94, 104 can even be formed facing in totally different directions to increase the effectiveness of the plate 30, 30′, 90, 100 within the wood fastening or shattering prevention applications. The dimensions of the polymer legs 34, 94, 104 are not reliant on the thickness of the plate base 32, 92, 102 within the manufacturing process and raw material used to form the plate. To save raw material costs, material can be extracted in parts of the plate, corresponding to the apertures 44, 98 and 108, leading to inconsistency of the thickness of the plate but still having the same strength compared to a consistent, solid material plate.

The current invention may be used within wood fastening and wood shattering process applications, including roof trusses, pallets and any other wood fastening applications where a connector plate, gang nail, split plate or truss plate is required to connect 2 or more wooden components or used to secure wood vessels from splitting The limitations identified in the prior art revolve around the material used to form the steel plate 10 and the process used to manufacture the plate 10. As described above, the steel connector plates 10 are formed through a press, punch, bending and cutting processes, using the material available within the plate to semi-extract and form the plate legs 18. The legs 18 will always be the same thickness of the plate base 20, where the material is semi-extracted from. The legs 18 will always face each other or will turn and face in the opposite direction. The legs 18 are formed in a consistent pattern and cannot be placed to face right or left compared to the leg in front or behind the leg in question.

The advantages of the present invention include:
1. The size (i.e. the length, breadth and width) of the legs of the connector plate is independent of the size or thickness of the plate used when producing the connector plate.
2. The shape of the legs of the plate are unlimited where the shape can be triangular or round, facing or opposite or turned away in a left or right direction to the other legs on the plate.
3. Material on the plate can be decreased by inconsistencies of the plate thickness as shown in FIG. 3.
4. Reinforced polymer includes properties protecting the product from corrosion or rust and has self-extinguish properties
5. Where metal material is slit to the size of the specific connector plate, reinforced pellet is used to form the plate without an added slitting process.
6. The cost of reinforced pellets is substantially lower compared to slit steel used in the traditional manufacturing process of connector plates.

1. A polymer connector plate comprising:
a polymer connector plate base; and
a plurality of elongate polymer legs extending from the plate base.

2. The polymer connector plate of claim 1, wherein the breadth or thickness of each polymer leg can be equal, smaller or thicker than the thickness of the connector base plate.

3. The polymer connector plate of claim 1, wherein the lengths of the plurality of elongate polymer legs vary from leg to leg.

4. The polymer connector plate of claim 1, wherein each elongate polymer leg is substantially round and terminates in a pointed end.

5. The polymer connector plate of claim 1, wherein each elongate polymer leg is substantially flat, comprising a pair of opposed major faces and a pair of opposed minor faces.

6. The polymer connector plate of claim 5, wherein the polymer leg comprises a leg base from which the opposed major and minor faces extend, the major and minor faces terminating in an upper leg surface, with the area of the upper leg surface is smaller than the area of the leg base, so that the cross-sectional area of the leg tapers from the leg base to the upper leg surface.

7. The polymer connector plate of claim 5, wherein the orientations of the polymer legs vary from leg to leg.

8. The polymer connector plate of claim 1, wherein the polymer connector plate base defines a plurality of apertures between the polymer legs.

9. A method of manufacturing a polymer connector plate, the method comprising extruding raw plastic polymer material to define the polymer connector plate defined in claim 1.

10. An apparatus for manufacturing a polymer connector plate, the apparatus comprising:
an injection moulding apparatus comprising a hopper to receive raw plastic polymer material, and an injection moulding housing accommodating a reciprocating barrel and screw for delivering an extruded polymer compound; and
a mould for receiving the extruded polymer compound, the mould being arranged to define the polymer connector plate defined in claim 1.

11. The polymer connector plate of claim 2, wherein the lengths of the plurality of elongate polymer legs vary from leg to leg.

12. A method of manufacturing a polymer connector plate, the method comprising extruding raw plastic polymer material to define the polymer connector plate defined in claim 2.

13. A method of manufacturing a polymer connector plate, the method comprising extruding raw plastic polymer material to define the polymer connector plate defined in claim 3.

14. A method of manufacturing a polymer connector plate, the method comprising extruding raw plastic polymer material to define the polymer connector plate defined in claim 4.

15. A method of manufacturing a polymer connector plate, the method comprising extruding raw plastic polymer material to define the polymer connector plate defined in claim 5.

16. A method of manufacturing a polymer connector plate, the method comprising extruding raw plastic polymer material to define the polymer connector plate defined in claim 6.

17. A method of manufacturing a polymer connector plate, the method comprising extruding raw plastic polymer material to define the polymer connector plate defined in

18. A method of manufacturing a polymer connector plate, the method comprising extruding raw plastic polymer material to define the polymer connector plate defined in claim 8.
